(19) United States
(12) Patent Application Publication
(10) Pub. No.: US 2023/0172233 A1
(43) Pub. Date: Jun. 8, 2023

(54) A METHOD FOR IMPROVING THE NUTRITIONAL VALUE OF ANIMAL FEED

(71) Applicant: DSM IP ASSETS B.V., Heerlen (NL)

(72) Inventor: Aaron COWIESON, Kaiseraugst (CH)

(21) Appl. No.: 17/924,327

(22) PCT Filed: May 17, 2021
(86) PCT No.: PCT/EP2021/062927

§ 371 Date: Nov. 9, 2022

(30) Foreign Application Priority Data
May 15, 2020 (EP) 20174993.4

(51) Int. Cl. A23K 20/26; A23K 20/189; A23K 50/10; A23K 50/30; A23K 50/75

(52) U.S. Cl. CPC A23K 20/26; A23K 20/189; A23K 50/10; A23K 50/30; A23K 50/75

(57) ABSTRACT

Offering broiler chickens a low protein diet supplemented with an array of synthetic amino acids is not fully effective in promoting maximal growth and both bodyweight and feed conversion ratio (FCR). However the present invention shows, growth rate and FCR can be promoted by the addition of available Phosphorus to the low protein diet and that this strategy is effective in restoring performance losses associated with the diet with low protein concentration. Therefore, the present invention relates to a method for improving the nutritional value of animal feed comprising a marginal protein content. More specifically, the invention relates to a method for improving weight gain and feed conversion ratio, which method comprises feeding the animal with a low protein diet and an extra supplementation of phosphorous.

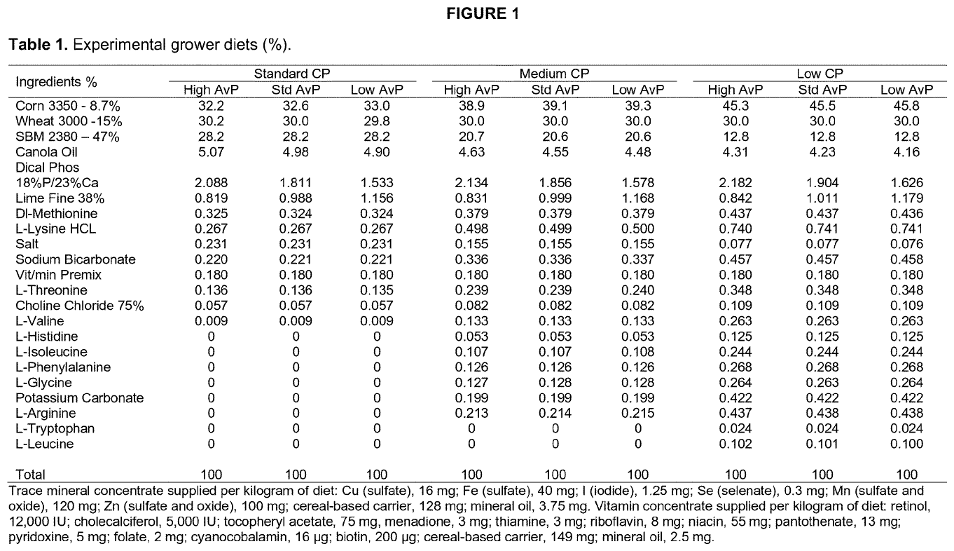

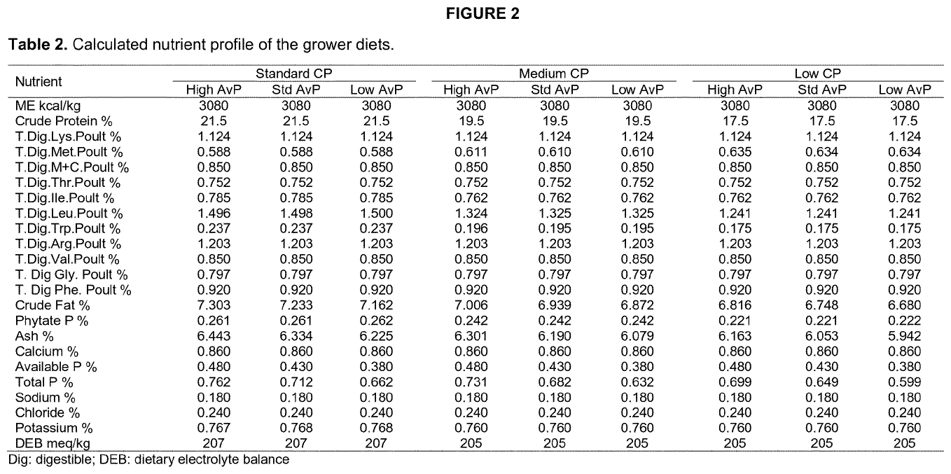

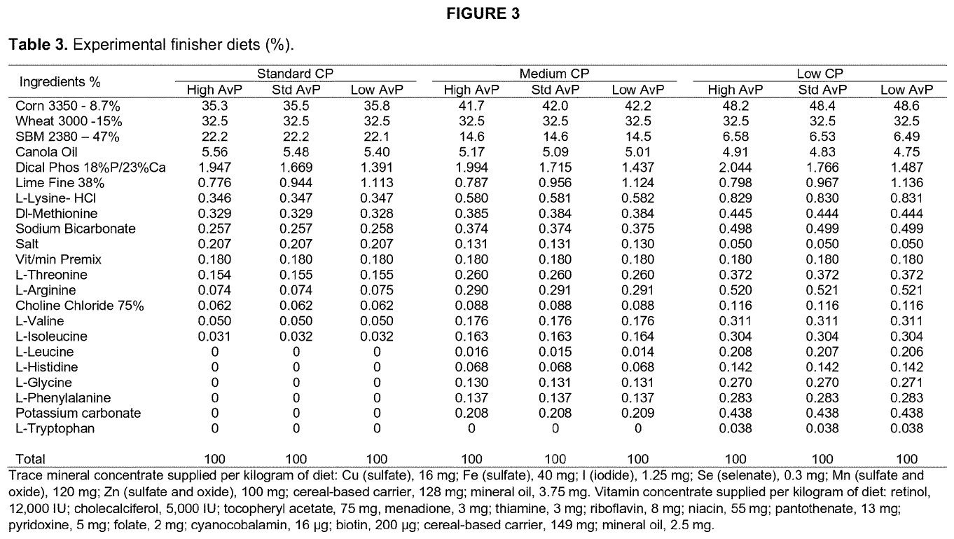

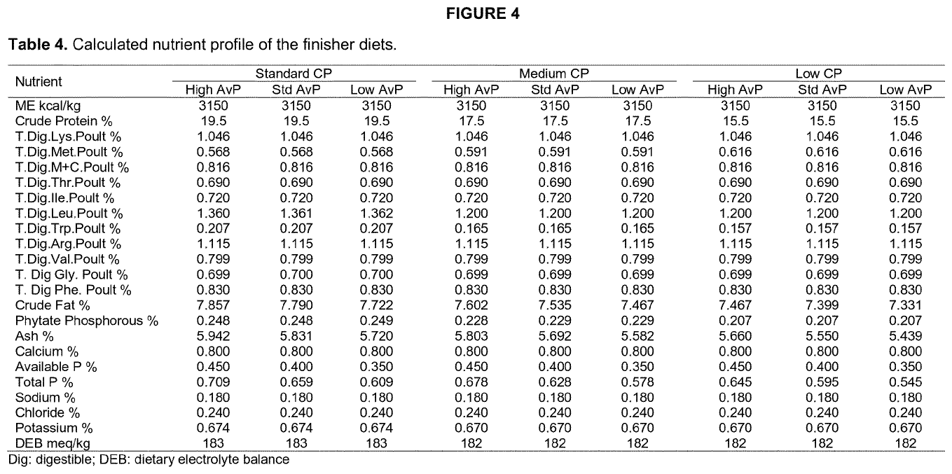

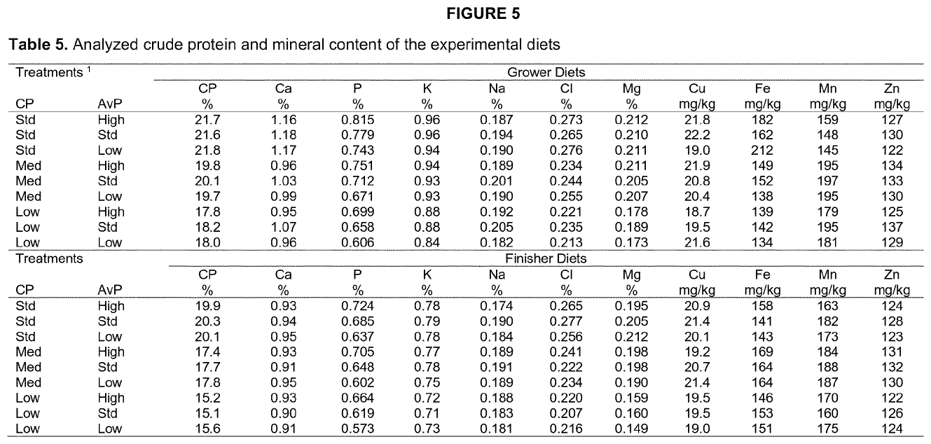

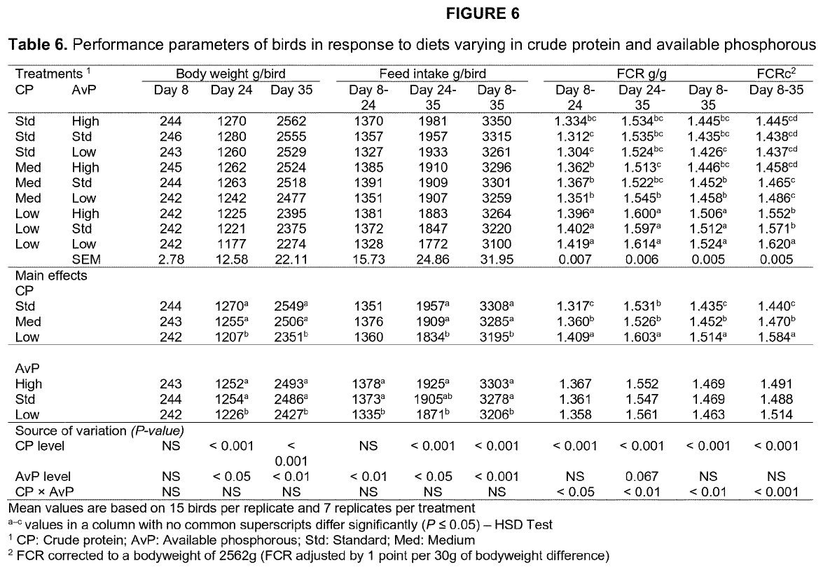

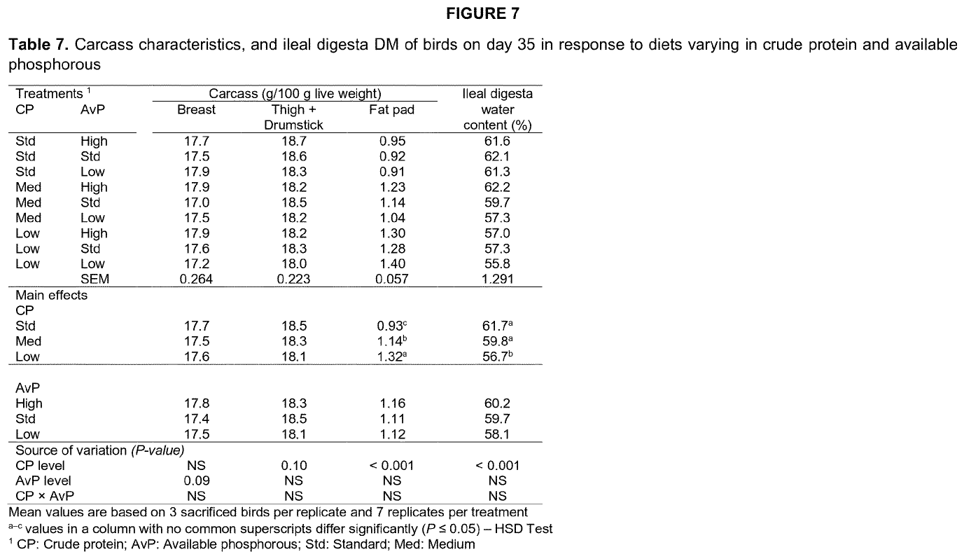

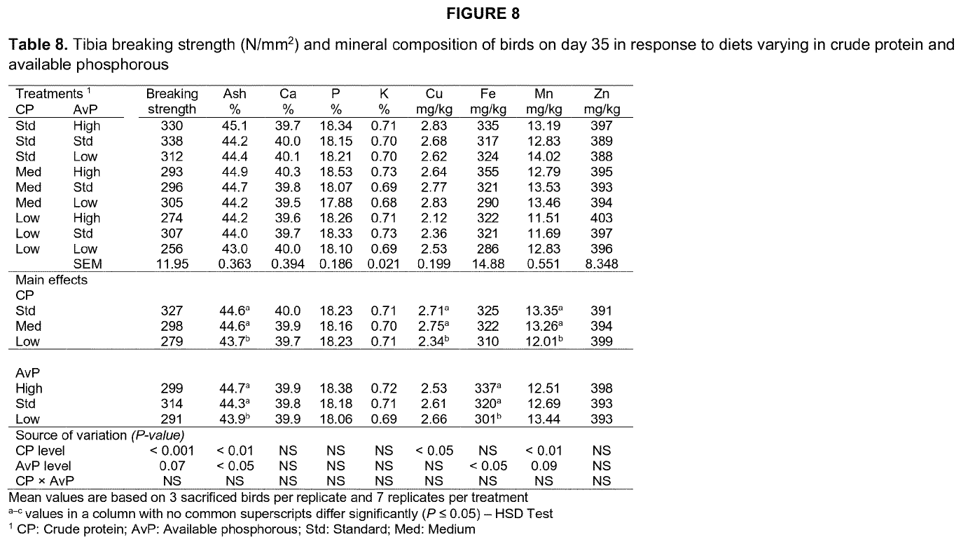

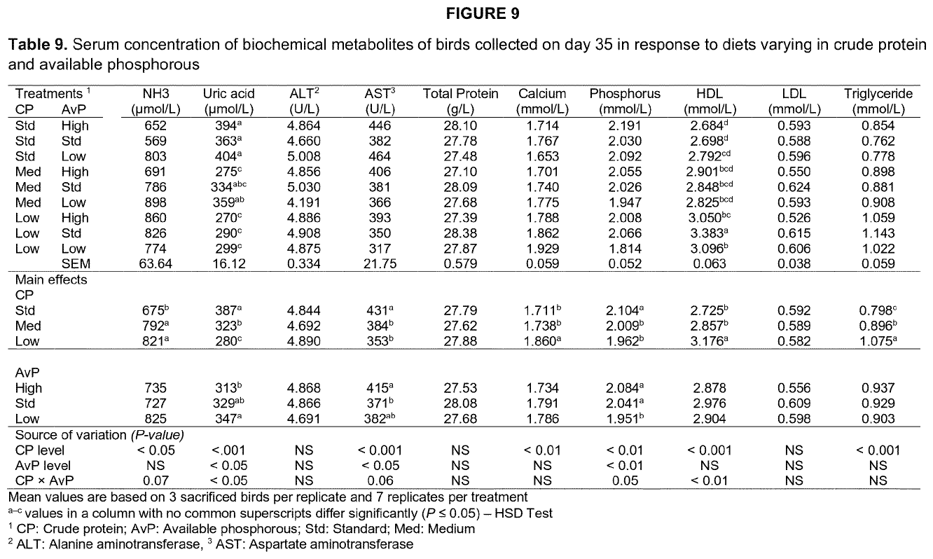

The present invention relates to a method for improving the nutritional value of animal feed characterized by a marginal protein content. More specifically, the invention relates to a method for improving weight gain and feed conversion ratio (FCR), which method comprises feeding the animal with a low protein diet and an extra supplementation of phosphorous.

Prior to the availability of synthetic amino acids, broiler diets were formulated to contain more than 70% soybean meal (SBM) and 35% crude protein in order to meet the requirement for the first limiting amino acid, methionine. Following the introduction of synthetic methionine, and later, lysine and threonine, broiler diets can be formulated with SBM inclusion of between 25-30% and crude protein concentrations of 18-22% while still satisfying the birds requirement for essential amino acids. Further reductions in dietary crude protein are desirable to promote economic and environmental sustainability of poultry production. However, the response of broiler chickens to radically low protein concentrations varies, even when augmented with an array of synthetic amino acids and feeding diets with high protein and energy concentrations remains associated with maximum growth performance and somatotropic response. Reasons for the variability in response of broilers to low protein diets and supplemental synthetic amino acids are not clear but may be associated with alterations to dietary fibre or potassium (K) content with changing SBM inclusion, a general requirement for nitrogen, non-essential amino acids or perhaps amino acids that are conditionally essential such as glycine and serine.

One overlooked axis in feeding low protein diets to livestock is the supply of digestible phosphorus (P). Maize contains around 0.23% phytate-P and 0.08% non-phytate P and this is similar for alternative cereal grains. Alternatively, SBM contains around 0.38% phytate-P and 0.25% non-phytate-P. Thus, both the total concentration of phytate-P and total P and the ratio of phytate-P to total P in cereals (75-80%) and in SBM (50-60%) are substantially different and these differences declare themselves in the bioavailability of P in these grains.

Thus, it has been surprisingly found that at the objective of the present invention the performance of broiler chickens (Weight Gain & FCR) can be enhanced by supplementation of low protein diets that are balanced in amino acid provision and potassium, with additional digestible P.

Moreover, it has been found surprisingly that in addition to the above function, feeding of additional digestible P in combination with a low protein diet has the advantage of being able to improve digestibility of proteins in animal feeds, i.e. to promote amino acid and nitrogen assimilation, and to increase total energy levels.

Therefore, the present invention relates to a method for improving nitrogen utilization in an animal, the method comprising the steps of administering an animal feed composition comprising a low protein diet and an available phosphorous concentration to said animal, wherein said low protein diet contains at least 5% less crude protein than a standard protein diet for optimal growth performance of the target animal species and wherein the concentration of available phosphorous associated with enhanced animal performance is higher in said animal feed compared to an animal feed comprising a standard protein diet.

The invention furthermore relates to a method of improving weight gain and/or feed conversion ratio in an animal, the method comprising the steps of administering an animal feed composition comprising a low protein diet and an available phosphorous concentration to said animal, wherein said low protein diet contains at least 5% less crude protein than a standard protein diet for optimal growth performance of the target animal species and wherein the concentration of available phosphorous associated with enhanced animal performance is higher in said animal feed compared to an animal feed comprising a standard protein diet.

An improved weight gain means an improved daily, weekly, bi-weekly, or monthly weight gain (in g or kg per the relevant time period), relative to a control without added phytase and protease.

The Feed Conversion Ratio (FCR) is indicative of how effectively a feed is utilized. The lower the FCR, the better the feed is utilized. The FCR may be determined on the basis of an animal trial comprising a first treatment in which the phytase and protease for use according to the invention are added to the animal feed in a desired concentration (e.g., 6 or 30 mg enzyme protein per kg feed), and a second treatment (control) with no addition of the enzymes to the animal feed. In particular embodiments, the FCR is improved (i.e., reduced) as compared to the control by at least 1.0%, preferably at least 1.5%, 1.6%, 1.7%, 1.8%, 1.9%, 2.0%, 2.1%, 2.2%, 2.3%, 2.4%, or at least 2.5%. In further particular embodiments, the FCR is improved (i.e. reduced) as compared to the control by at least 2.6%, 2.7%, 2.8%, 2.9%, or at least 3.0%. In still further particular embodiments, the FCR is improved (i.e., reduced) as compared to the control by at least 3.1%, 3.2%, 3.3%, 3.4%, 3.5%, 3.6%, 3.7%, or at least 3.8%.

The term “energy” and “energy level” as used herein denotes the total energy levels of the diets and ileal contents determined by calorimeteric measurement.

The term “nitrogen assimilation” and “total nitrogen” as used herein denotes the total nitrogen concentration determined on the freeze-dried diets and ileal contents.

The term “amino acid assimilation” and “total amino acids” as used herein denotes the total amino acids determined after an acidic hydrolysis on the freeze-dried diets and intestinal contents.

The presently disclosed methods and compositions can be used to enhance the performance (increase weight gain or reduce feed conversion ratio) of domestic animals including domesticated pets (such as dogs, cats etc.), working animals (such as horse, oxen, racing animals etc.) and livestock (cattle, sheep, pigs, poultry etc.) reared on diets with a low protein concentration.

A low protein diet according to the present invention is defined as a diet that contains up to 30% less crude protein than the primary breeding company would recommend for optimal growth performance of the target species. In an embodiment, the target amount of protein in the diet is at least 30%, at least 25%, at least 20%, at least 15%, at least 10% or at least 5% less that the protein requirement of the target species as defined by the primary breeder recommendations and at a given age/stage of production.

Increasing the available phosphorous concentration in the diet may be achieved by multiple approaches. In one embodiment this may be achieved by increasing the dietary concentration of inorganic phosphate (monocalcium phosphate, dicalcium phosphate, defluorinated phosphate etc.).

In another embodiment this may be achieved by increasing the digestibility of organic phosphate (phytate-bound phosphate or organic, non-phytate phosphate) by use of supplemental exogenous enzymes (phytase, protease, carbohydrase etc.) or through alternative interventions such as, but not limited to, acidification of drinking water, reduction in the concentration of dietary cations (calcium, zinc, copper etc.) or through the use of intermittent lighting programs or feeding of whole-grain cereals to enhance gastric gut development.

In an embodiment the use of supplemental phytase at inclusion concentrations of at least 5000 FYT/kg, at least 4000 FYT/kg, at least 3000 FYT/kg, at least 2000 FYT/kg, at least 1000 FYT/kg or at least 500 FYT/kg would be recommended to enhance the supply of digestible phosphorus in the diet.

Phytases (myo-inositol hexakisphosphate phosphohydrolases; EC 3.1.3.8) are enzymes that hydrolyze phytate (myo-inositol hexakisphosphate) to myo-inositol and inorganic phosphate and are known to be valuable feed additives.

A variety of Phytases differing in pH optima, substrate specificity, and specificity of hydrolysis have been identified in plants and fungi. Acid Phytases from wheat bran and Aspergilli have been extensively studied and the stereo specificity of hydrolysis has been well established.

Based on the specificity of initial hydrolysis, two classes of acid Phytases are recognized by the International Union of Pure and Applied Chemistry and the International Union of Biochemistry (IUPAC-IUB, 1975), the 6-Phytase, found for example in plants, and the 3-Phytase, found in fungi. The 6-Phytase hydrolyses the phosphate ester at the L-6 (or D-4) position of phytic acid, and the 3-Phytase hydrolyses the phosphate ester at the D-3 position.

The ENZYME site at the internet (http://www.expasy.ch/enzyme/) is a repository of information relative to the nomenclature of enzymes. It is primarily based on the recommendations of the Nomenclature Committee of the International Union of Biochemistry and Molecular Biology (IUB-MB) and it describes each type of characterized enzyme for which an EC (Enzyme Commission) number has been provided (Bairoch A. The ENZYME database, 2000, Nucleic Acids Res 28:304-305). See also the handbook Enzyme Nomenclature from NC-IUBMB, 1992).

According to the ENZYME site, two different types of phytases are known: A so-called 3-phytase (myo-inositol hexaphosphate 3-phosphohydrolase, EC 3.1.3.8) and a so-called 6-phytase (myo-inositol hexaphosphate 6-phosphohydrolase, EC 3.1.3.26). For the purposes of the present invention, both types are included in the definition of phytase.

Examples of ascomycete phytases are those derived from a strain of Aspergillus, for example Aspergillus awamori PHYA (SWISSPROT P34753, Gene 133:55-62 (1993)), Aspergillus niger (ficuum) PHYA (SWISSPROT P34752, EP 420358, Gene 127:87-94 (1993)), Aspergillus awamori PHYB (SWISSPROT P34755, Gene 133:55-62 (1993)), Aspergillus niger PHYB (SWISSPROT P34754, Biochem. Biophys. Res. Commun. 195:53-57(1993)); or a strain of Emericella, for example Emericella nidulans PHYB (SWISSPROT 000093, Biochim. Biophys. Acta 1353:217-223 (1997)); or a strain of Thermomyces (Humicola), for example the Thermomyces lanuginosus phytase described in WO 97/35017. Other examples of ascomycete phytases are disclosed in EP 684313 (for example derived from strains of Aspergillus fumigatus, Aspergillus terreus, and Myceliophthora thermophila); JP 11000164 (a phytase derived from a strain of Penicillium.); U.S. Pat. No. 6,139,902 (a phytase derived from a strain of Aspergillus), and WO 98/13480 (Monascus anka phytase).

Examples of basidiomycete phytases are the phytases derived from Paxillus involutus, Trametes pubescens, Agrocybe pediades and Peniophora lycii (see WO 98/28409).

In the present context, a preferred Phytase according to the invention is classified as belonging to the EC 3.1.3.26 group. The EC numbers refer to Enzyme Nomenclature 1992 from NC-IUBMB, Academic Press, San Diego, Calif., including supplements 1-5 published in Eur. J. Biochem. 1994, 223, 1-5; Eur. J. Biochem. 1995, 232, 1-6; Eur. J. Biochem. 1996, 237, 1-5; Eur. J. Biochem. 1997, 250, 1-6; and Eur. J. Biochem. 1999, 264, 610-650; respectively. The nomenclature is regularly supplemented and updated; see e.g. the World Wide Web at http://www.chem.qmw.ac.uk/iubmb/enzyme/index.html.

Examples of Phytases for use according to the present inventions are:

Phytases derived from strains of E coli, from strains of Buttiauxella, Ascomycete Phytases as disclosed in EP 684313 (for example derived from strains of Aspergillus fumigatus, Aspergillus terreus, and Myceliophthora thermophile); JP 11000164 (a Phytase derived from a strain of Penicillium.); U.S. Pat. No. 6,139,902 (a Phytase derived from a strain of Aspergillus), WO 98/13480 (Monascus anka Phytase), WO 2008/116878 and WO 2010/034835 (Hafnia phytase).

A preferred Phytase for use according to the invention is derived from a species of E coli, Peniophora, Citrobacter, Hafnia or Buttiauxella.

Examples of Peniophora species are: Peniophora aurantiaca, P. cinerea, P. decorticans, P. duplex, P. ericsonii, P. incamate, P. lycii, P. meridionalis, P. nuda, P. piceae, P. pini, P. pithya, P. polygonia, P. proxima, P. pseudo-pini, P. rufa, P. versicolor, and species simply classified as Peniophora sp. A preferred species is Peniophora lycii. A preferred strain is Peniophora lycii CBS 686.96.

For purposes of the present invention, preferred phytases are the phytases contained in the following commercial products: Ronozyme®HiPhos, Ronozyme®NP and Ronozyme® P (DSM Nutritional Products AG), Natuphos™ (BASF), Finase® and Quantum® Blue (AB Enzymes), OptiPhos® (Huvepharma) Phyzyme® XP (Verenium/DuPont) and Axtra® PHY (DuPont).

For the purposes of the present invention the phytase activity is determined in the unit of FYT, one FYT being the amount of enzyme that liberates 1 micro-mol inorganic ortho-phosphate per min. under the following conditions: pH 5.5; temperature 37° C.; substrate: sodium phytate (C6H6O24P6Na12) in a concentration of 0.0050 mol/l. Suitable phytase assays are the FYT and FTU assays described in Example 1 of WO 00/20569. FTU is for determining phytase activity in feed and premix.

Specific activity is measured on highly purified samples (an SDS poly acryl amide gel should show the presence of only one component). The enzyme protein concentration may be determined by amino acid analysis, and the phytase activity in the units of FYT. Specific activity is a characteristic of the specific phytase variant in question, and it is calculated as the phytase activity measured in FYT units per mg phytase enzyme protein.

For determining mg Phytase protein per kg feed or feed additive, the enzyme is purified from the feed composition or the feed additive, and the specific activity of the purified enzyme is determined using a relevant assay. The Phytase activity of the feed composition or the feed additive is also determined using the same assay, and on the basis of these two determinations, the dosage in mg Phytase protein per kg feed is calculated.

According to the invention, the phytase should of course be applied in an effective amount, i.e. in an amount adequate for improving nutritional value of feed if it is used in combination with a proteolytic enzyme [obtaining the desired effect, e.g. improving FCR]. It is at present contemplated that the phytase is administered in such amounts that the specific activity in the final feed is between 1000 FYT/kg feed and 5000 FYT/kg feed. In particular embodiments, the specific activity is at least 1500, 1700, 1900, 2000, 2100, 2300, 2500, 2700, 2900, 3000, 3100, 3300, 3500, 3700, 3900, 4100, 4300, 4500, 4700, 4900 or 5000 FYT/kg feed.

Other enzymes that can be used according to the present invention are proteolytic enzymes. Proteolytic enzymes or proteases, or peptidases, catabolize peptide bonds in proteins breaking them down into fragments of amino acid chains, or peptides.

Proteases are classified on the basis of their catalytic mechanism into the following groups: serine proteases (S), cysteine proteases (C), aspartic proteases (A), metalloproteases (M), and unknown, or as yet unclassified, proteases (U), see Handbook of Proteolytic Enzymes, A. J. Barrett, N. D. Rawlings, J. F. Woessner (eds), Academic Press (1998), in particular the general introduction part.

Proteases for use according to the invention are acid stable proteases, preferably acid stable serine proteases.

In a particular embodiment, the protease for use according to the invention is a microbial protease, the term microbial indicating that the protease is derived from, or originates from a microorganism, or is an analogue, a fragment, a variant, a mutant, or a synthetic protease derived from a microorganism. It may be produced or expressed in the original wild-type microbial strain, in another microbial strain, or in a plant; i. e. the term covers the expression of wild-type, naturally occurring proteases, as well as expression in any host of recombinant, genetically engineered or synthetic proteases.

Examples of microorganisms are bacteria, e. g. bacteria of the phylum Actinobacteria phy. nov., e. g. of class I: Actinobacteria, e. g. of the Subclass V: Actinobacteridae, e. g. of the Order I: Actinomycetales, e. g. of the Suborder XII: Streptosporangineae, e. g. of the Family II: Nocardiopsaceae, e. g. of the Genus I: Nocardiopsis, e. g. Nocardiopsis sp. NRRL 18262, and Nocardiopsis alba e.g. of the species Bacillus or mutants or variants thereof exhibiting protease activity. This taxonomy is on the basis of Berge's Manual of Systematic Bacteriology, 2nd edition, 2000, Springer (preprint: Road Map to Bergey's).

Preferred proteases according to the invention are acid stable serine proteases obtained or obtainable from the order Actinomycetales, such as those derived from Nocardiopsis dassonvillei subsp. dassonvillei DSM 43235 (A1918L1), Nocardiopsis prasina DSM 15649 (NN018335L1), Nocardiopsis prasina (previously alba) DSM 14010 (NN18140L1), Nocardiopsis sp. DSM 16424 (NN018704L2), Nocardiopsis alkaliphila DSM 44657 (NN019340L2) and Nocardiopsis lucentensis DSM 44048 (NN019002L2), as well as homologous proteases.

The term serine protease refers to serine peptidases and their clans as defined in the above Handbook. In the 1998 version of this handbook, serine peptidases and their clans are dealt with in chapters 1-175. Serine proteases may be defined as peptidases in which the catalytic mechanism depends upon the hydroxyl group of a serine residue acting as the nucleophile that attacks the peptide bond. Examples of serine proteases for use according to the invention are proteases of Clan SA, e. g. Family S2 (Streptogrisin), e. g. Sub-family S2A (alpha-lytic protease), as defined in the above Handbook.

Protease activity can be measured using any assay, in which a substrate is employed, that includes peptide bonds relevant for the specificity of the protease in question. Examples of protease substrates are casein, and pNA-substrates, such as Suc-AAPF-pNA (available e.g. from Sigma S-7388). Another example is Protazyme AK (azurine dyed crosslinked casein prepared as tablets by Megazyme T-PRAK). Example 2 of WO 01/58276 describes suitable protease assays. A preferred assay is the Protazyme assay of Example 2D (the pH and temperature should be adjusted to the protease in question as generally described previously).

There are no limitations on the origin of the acid stable serine protease for use according to the invention. Thus, the term protease includes not only natural or wild-type proteases, but also any mutants, variants, fragments etc. thereof exhibiting protease activity, as well as synthetic proteases, such as shuffled proteases, and consensus proteases. Such genetically engineered proteases can be prepared as is generally known in the art, e. g. by Site-directed Mutagenesis, by PCR (using a PCR fragment containing the desired mutation as one of the primers in the PCR reactions), or by Random Mutagenesis. The preparation of consensus proteins is described in e. g. EP 0 897 985.

Examples of acid-stable proteases for use according to the invention are proteases derived from Nocardiopsis sp. NRRL 18262, and Nocardiopsis alba and proteases of at least 60, 65, 70, 75, 80, 85, 90, or at least 95% amino acid identity to any of these proteases.

For calculating percentage identity, any computer program known in the art can be used. Examples of such computer programs are the Clustal V algorithm (Higgins, D. G., and Sharp, P. M. (1989), Gene (Amsterdam), 73, 237-244 and the GAP program provided in the GCG version 8 program package (Program Manual for the Wisconsin Package, Version 8, Genetics Computer Group, 575 Science Drive, Madison, Wis., USA 53711) (Needleman, S. B. and Wunsch, C. D., (1970), Journal of Molecular Biology, 48, 443-453.

In another particular embodiment, the protease for use according to the invention, besides being acid-stable, is also thermostable.

The term thermostable means for proteases one or more of the following: That the temperature optimum is at least 50° C., 52° C., 54° C., 56° C., 58° C., 60° C., 62° C., 64° C., 66° C., °68 C, or at least °70 C.

A commercially available serine proteases derived from Nocardiopsis is Ronozyme®ProAct® (DSM Nutritional Products AG).

The term feed or feed composition according to the invention means an animal feed comprising a low protein concentration/diet as defined above. It can be any compound, preparation, mixture, or composition suitable for, or intended for intake by an animal.

The compounds of the invention, which are able to enhance animal performance if a low protein diet is used and/or improve nitrogen digestibility of low protein diets as for example inorganic phosphates or exogenous enzymes may be designated as an animal feed additive. Such an additive always comprises the compound in question, preferably in the form of stabilized liquid or dry compositions. The additive may also comprise other components or ingredients of animal feed. The so-called pre-mixes for animal feed are particular examples of such animal feed additives. Pre-mixes may contain the compound(s) in question, and in addition at least one vitamin and/or at least one mineral.

Accordingly, in a particular embodiment, in addition to the compound, the feed additive or premix may comprise or contain at least one fat-soluble vitamin, and/or at least one water-soluble vitamin, and/or at least one trace mineral. Also at least one macro mineral may be included.

Examples of fat-soluble vitamins are vitamin A, D3, E, and vitamin K, e.g. vitamin K3.

Examples of water-soluble vitamins are vitamin B12, biotin and choline, vitamin B1, vitamin B2, vitamin B6, niacin, folic acid and panthothenate, e.g. Ca-D-panthothenate.

Examples of trace minerals are manganese, zinc, iron, copper, iodine, selenium, and cobalt.

Examples of macro minerals are calcium, phosphorus and sodium.

Further, optional, feed-additive ingredients are colouring agents, aroma compounds, stabilizers, additional enzymes, and antimicrobial peptides.

Additional enzyme components of the composition of the invention include at least one polypeptide having xylanase activity; and/or at least one polypeptide having endoglucanase activity; and/or at least one polypeptide having endo-1,3(4)-beta-glucanase activity.

Xylanase activity can be measured using any assay, in which a substrate is employed, that includes 1,4-beta-D-xylosidic endo-linkages in xylans. Different types of substrates are available for the determination of xylanase activity e.g. Xylazyme cross-linked arabinoxylan tablets (from MegaZyme), or insoluble powder dispersions and solutions of azo-dyed arabinoxylan.

Endoglucanase activity can be determined using any endoglucanase assay known in the art. For example, various cellulose- or beta-glucan-containing substrates can be applied. An endoglucanase assay may use AZCL-Barley beta-Glucan, or preferably (1) AZCL-HE-Cellulose, or (2) Azo-CM-cellulose as a substrate. In both cases, the degradation of the substrate is followed spectrophotometrically at OD595 (see the Megazyme method for AZCL-polysaccharides for the assay of endo-hydrolases at http://www.megazyme.com/booklets/AZCLPOL.pdf.

Endo-1,3(4)-beta-glucanase activity can be determined using any endo-1,3(4)-beta-glucanase assay known in the art. A preferred substrate for endo-1,3(4)-beta-glucanase activity measurements is a cross-linked azo-coloured beta-glucan Barley substrate, wherein the measurements are based on spectrophotometric determination principles.

The present invention is further described by the following examples which should not be construed as limiting the scope of the invention.

### EXAMPLE: ANIMAL TRIAL

### Summary

A total of 945 male Ross 308 broiler chicks were used in a growth study to explore the interaction between dietary crude protein concentration and available phosphorus. Nine experimental treatments were constructed factorially by offering low, medium or standard protein concentrations without or with low, standard or high available phosphorus. Diets were based on corn, wheat and soybean meal and all nutrients other than protein/amino acids and available phosphorus were maintained at or above breeder guidelines. Additional synthetic amino acids were used in the diets with low protein concentration in attempt to maintain digestible amino acid supply. Diets were offered to 7 replicate pens of 15 chicks per pen from d8 to 35. Growth performance was measured during the grower (d8-24) and finisher (d25-35) periods. On d35 carcass composition was determined, blood was drawn for various biochemical measurements and the tibia was excised for mechanical and compositional analyses. Birds that received the low protein diet had lower terminal bodyweight and poorer feed conversion ratio compared with those that received diets with adequate crude protein content. However, addition of available phosphorus to the low protein diet resulted in significant reductions in weight-corrected feed conversion that were not evident in the diet with standard protein content. Bone architecture was only moderately influenced by dietary treatment but birds that ingested the low protein diets had relatively heavier abdominal fat pad weight. Blood biochemistry was influenced by both dietary protein and available phosphorus and trends suggested that both axes are involved in protein accretion and catabolism. It can be concluded that performance losses associated with feeding low protein diets to broiler chickens may be partially restored by additional available phosphorus. The implications for use of exogenous enzymes such as protease and phytase and protein nutrition per se warrants further examination.

Materials and Methods

Birds and Diets

The study procedures were reviewed and approved by the University of New England Animal Ethics Committee to ensure compliance with welfare and humane practices.

A total of 990 off-sex male broiler chickens (Ross 308) were obtained from a local hatchery (Aviagen, Goulburn, NSW, Australia). All chicks were offered a common starter diet formulated to meet or exceed Ross 308 nutrient specifications (Aviagen, 2014) with an apparent metabolizable energy (AME) content of 3,000 kcal/kg, 1.28% digestible lysine, 0.90% calcium (Ca) and 0.45% available P. On d8, 945 healthy chicks were weighed and distributed to 63 floor pens, 15 chicks per pen, to achieve an equivalent pen weight (+/−50 g/pen). A total of 9 dietary treatments were generated by factorially arranging 3 concentrations of crude protein (21.5/19.5%, 19.5/17.5% or 17.5/15.5%; grower/finisher respectively) and 3 concentrations of available P (0.48/0.45%, 0.43/0.40% or 0.38/0.35%; grower/finisher respectively). Chicks were raised in a windowless and environmentally controlled house. The ambient temperature was initially set and maintained at 33±1.0° C. for the first three days upon chick's arrival and then gradually decreased by 1.0° C. every 2 days to reach 23.0° C. and kept constant thereafter to the end of the trial. Lighting and ventilation program followed the recommendations set forth in the Ross 308 breed management manual. Feed and water were available throughout the experiment ad libitum.

Diets were based on corn, wheat and SBM (Tables 1-4) and were formulated to be equivalent in all nutrients other than those that were the focus of the experiment. Digestible amino acids were added in increasing concentrations as dietary crude protein was reduced to ensure essential amino acid requirements were met, even at the lowest protein level. Dietary electrolyte balance an K provision was maintained as SBM was displaced by addition of K carbonate.

Measurements

Bodyweight gain and feed consumption were measured and FCR calculated for the grower (d8-24) and finisher (d25-35) periods and over the entire experimental period (d8-35). Mortality, on a pen basis, was used to correct FCR values. On d35 bodyweight corrected FCR (FCRc) was also calculated and presented as there were treatment-associated differences in bodyweight. This correction was achieved by consider a 30 g difference in bodyweight was equivalent to 1 point in FCR.

On d35, a total of 3 birds per pen were selected at random, electrically stunned and euthanized. Blood samples were individually collected in none-heparinized tubes from the jugular vein of two birds. Skinless breast meat, thigh+drumstick, and abdominal fat pad were removed, weighed and calculated as a percentage of live body weight. Tibia samples were also collected for breaking strength test and mineral composition analysis. The digesta content of the ileum (portion of the small intestine from Meckel's diverticulum to approximately 1 cm proximal to the ileocecal junction) were gently squeezed out and pooled per replicate pen, to determine digesta dry matter and water content.

Chemical Analysis

The nitrogen (N) content of feed samples, in duplicate, were determined from a 0.25-g sample in a combustion analyzer (Leco model FP-2000 N analyzer, Leco Corp., St. Joseph, Mich.) using EDTA as a calibration standard, with crude protein being calculated by multiplying percentage N by a correction factor (6.25). All diets (in duplicate) were analyzed for total N, and mineral profile (Table 5).

The tibias were subjected to breaking strength test using an Instron instrument (Model 1011 Instron Universal Testing Machine, Instron Corp., Canton, USA, MA) with Automated Materials Test System software version 4.2. The samples were placed on vertical brackets set 40 mm apart and a 10 mm compression rob was positioned near the center of the bone. The instrument was equipped with a 50 kg load cell and a crosshead speed of 50 mm/min was used during the breaking strength determination. Following the breaking strength test, the broken tibia samples were collected and dried for 24 h at 105° C. in a drying oven (Qualtex Universal Series 2000, Watson Victor Ltd., Perth, Australia) and reweighed after cooling in a desiccator. The dried tibias were then ashed in a Carbolite CWF 1200 chamber furnace (Carbolite, Sheffield, UK) at 600° C. for 6 hours after starting at 300° C. with a 1 h ramp up time. Moisture-free tibia ash was expressed as the percentage of tibia ash relative to dry tibia weight. The ash samples were further ground. The mineral content of the tibia ash and diets samples were determined using inductively coupled plasma-optical emission spectrometer (ICP-OES) (Agilent, Mulgrave, Victoria, Australia).

Blood samples were allowed to clot for 30 mins at room temperature and then centrifuged at 3,000×g for 10 min at 4° C. (SIGMA 4-15 Lab Centrifuge, Germany) to separate the serum. Individual serum samples were analyzed for ammonia, uric acid, total protein, high density lipoprotein (HDL), low-density lipoprotein (LDL) cholesterol and triglyceride, calcium, phosphorous, alanine aminotransferase (ALT), and aspartate aminotransferase (AST) on Thermo Scientific™ Indiko™ and Konelab™ auto-analyzer, using a kit package specific to each test.

Ileal digesta samples were weighed and then oven dried at 95° C. for 24 hours to a constant weight. The dried samples were reweighed, and the weight difference was used to calculate digesta water content.

Statistical Analysis

Data were checked for normality and then subjected to statistical analysis using 2-way ANOVA of GLM procedure of SAS to assess the main effects of crude protein levels, AvP, and their interaction. Each pen was considered an experimental unit and the values presented in the tables are means with pooled standard error of mean (SEM). If a significant effect was detected, differences between treatments or main effects were separated by least square differences test. Significance was considered at P<0.001, P<0.01, P<0.05 and P<0.1 was indicated as a trend.

Results

Analyzed nutrient concentrations in the experimental diets are expressed in Table 5 and confirmed that diets had been correctly formulated and mixed. The desired crude protein, total phosphorus and electrolyte levels were achieved and within acceptable ranges for sampling and analytical error.

The interactive effects of crude protein and available P on the performance of broiler chickens is presented in Table 6. Increasing crude protein and available P concentration resulted in an increase (P<0.01) in bodyweight on d24 and d35 and for feed intake in both grower and finisher phases. There was no interaction (P>0.05) between dietary crude protein and available P for bodyweight or feed intake. Increasing available P generated a reduction in FCRc that was dependent on dietary crude protein concentration resulting in a significant protein*P interaction. Indeed, increasing available P in the diet with standard protein concentration had no effect on FCRc whereas in the moderate and low protein diets a reduction in FCRc of approximately 3.5 and 7 points respectively was achieved.

The effect of dietary protein and available P concentration on carcass composition and water content of the ileal digesta is presented in Table 7. There were no effects (P>0.05) of available P concentration on any of the carcass parameters measured or on ileal digesta water content and no interaction (P>0.05) between protein and P on these parameters. However, there was a tendency (P=0.09) for breast yield to increase with increasing available P concentration. Increasing dietary crude protein concentration resulted in a significant increase in the water content of ileal digesta and a reduction (P<0.001) in abdominal fat pad concentration.

The effect of available P and crude protein on tibia breaking strength and mineral content of the bone is presented in Table 8. Increasing dietary crude protein (P<0.001) and available P (P=0.07) independently increased bone breaking strength. Similarly, bone ash concentration was increased (P<0.05) by elevating both available P and crude protein content in the feed. Tbia mineral composition was largely unaffected by diet protein or P concentration although manganese (Mn) and copper (Cu) content were significantly increased with increasing dietary protein content whereas increasing available P generated an increase (P<0.05) in tibia iron (Fe) content.

The interaction between dietary available P and crude protein concentrations on serum metabolites is presented in Table 9. Increasing dietary protein generated increases in plasma Ca and triglyceride concentration (P<0.01). Increasing dietary available P content resulted in a reduction in plasma uric acid concentration only at moderate crude protein level, resulting in a significant protein*P interaction. Increasing dietary protein content resulted in a reduction (P<0.01) in plasma NH₃. Increasing dietary available P and protein content resulted in an increase (P<0.01) in plasma P concentration. The increase in plasma P associated with increasing dietary available P concentration was more marked in low protein diets resulting in an interaction between available P and crude protein (P=0.05). There was an inconsistent influence of diet available P and protein concentrations on plasma HDL where increases in available P reduced HDL in standard protein diets but the opposite occurred in moderate and low protein diets (P<0.01).

Plasma AST was independently increased by increases in dietary available P (P<0.05) and protein (P<0.001) although the effect of available P on AST was more apparent in diets with a low protein concentration resulting in a tendency for an interaction between treatments (P=0.06). There was no effect (P>0.05) of dietary treatment on plasma ALT, total protein or LDL.

### CONCLUSIONS

It can be concluded that offering broiler chickens low protein diets supplemented with an array of synthetic amino acids was not fully effective in promoting maximal growth and both bodyweight and FCR were compromised relative to a higher protein diet. However, growth rate and FCR were promoted by addition of available P to the low protein diet and this strategy was effective in restoring performance losses associated with the diet with the lowest protein concentration.

1. A method of improving nitrogen utilization in an animal, the method comprising the steps of administering an animal feed composition comprising a low protein diet and an available phosphorous concentration to said animal, wherein said low protein diet contains at least 5% less crude protein than a standard protein diet for optimal growth performance of the target animal species and wherein the concentration of available phosphorous associated with enhanced animal performance is higher in said animal feed compared to an animal feed comprising a standard protein diet.

2. A method of improving weight gain and/or feed conversion ratio in an animal, the method comprising the steps of administering an animal feed composition comprising a low protein diet and an available phosphorous concentration to said animal, wherein said low protein diet contains at least 5% less crude protein than a standard protein diet for optimal growth performance of the target animal species and wherein the concentration of available phosphorous associated with enhanced animal performance is higher in said animal feed compared to an animal feed comprising a standard protein diet.

3. A method according to claim 1, wherein the low protein diet contains at least 30%, at least 25%, at least 20%, at least 15%, or at least 10% less crude protein than the standard diet of the target animal species.

4. A method according to claim 1 wherein the increase of available phosphorous concentration in the diet is achieved by
a. increasing the dietary concentration of inorganic phosphate,
b. additional supplementation of exogenous enzymes,
c. through alternative interventions such as, but not limited to, acidification of drinking water, reduction in the concentration of dietary cations or through the use of intermittent lighting programs or feeding of whole-grain cereals to enhance gastric gut development.

5. Method according to claim 4, wherein the increase of available phosphorous concentration in the diet is achieved by additional supplementation of at least one inorganic phosphate selected from the group consisting of monocalcium phosphate, dicalcium phosphate, defluorinated phosphate.

6. Method according to claim 4, wherein the increase of available phosphorous concentration in the diet is achieved by additional supplementation of at least one exogenous enzyme selected from the group consisting of phytase, protease, carbohydrase.

7. Method according to claim 6, wherein a supplemental phytase at inclusion concentrations of at least 5000 FYT/kg, at least 4000 FYT/kg, at least 3000 FYT/kg, at least 2000 FYT/kg, at least 1000 FYT/kg or at least 500 FYT/kg is used.

8. The method according to claim 1, wherein the phytase is classified as belonging to the EC 3.1.3.26 group.

9. The method according to claim 1, wherein the protease is an acid stable serine proteases obtained or obtainable from the order Actinomycetales.

10. The method according to claim 9, wherein the protease is an acid stable serine protease derived from Nocardiopsis dassonvillei subsp. dassonvillei DSM 43235 (A1918L1), Nocardiopsis prasina DSM 15649 (NN018335L1), Nocardiopsis prasina (previously alba) DSM 14010 (NN18140L1), Nocardiopsis sp. DSM 16424 (NN018704L2), Nocardiopsis alkaliphila DSM 44657 (NN019340L2) and Nocardiopsis lucentensis DSM 44048 (NN019002L2), as well as homologous proteases.

11. The method according to claim 1, wherein the animal is selected from poultry, pigs and cattle.

12. Use of an additional supplementation of inorganic phosphate in animal feed for improving weight gain and/or feed conversion, the digestibility of proteins and/or the assimilation of amino acids and/or nitrogen in animals and/or to increase total energy levels in animal feedstuff.

13. Use of an additional supplementation of exogenous phytase in animal feed for improving weight gain and/or feed conversion, the digestibility of proteins and/or the assimilation of amino acids and/or nitrogen in animals and/or to increase total energy levels in animal feedstuff.

14. Use according to claim 12, wherein said animal feed is characterized by a low protein diet containing at least 5% less crude protein than a standard protein diet for optimal growth performance of the target animal species.

15. Use according to claim 14, wherein the low protein diet contains at least 30%, at least 25%, at least 20%, at least 15%, or at least 10% less crude protein than the standard diet of the target animal species.

16. Use according to claim 12, wherein the animal is selected from poultry, pigs and cattle.
